(19) United States
(12) Patent Application Publication
(10) Pub. No.: US 2024/0200245 A1
(43) Pub. Date: Jun. 20, 2024

(54) SUPER-SOFT COMPOSITE WIPING NON-WOVEN FABRIC AND MANUFACTURING METHOD THEREFOR

(71) Applicant: XIAMEN YANJAN NEW MATERIAL CO., LTD., Fujian (CN)

(72) Inventors: Shihuang LI, Fujian (CN); Chaosheng WU, Fujian (CN); Yonggong CHEN, Fujian (CN)

(21) Appl. No.: 18/288,197

(22) PCT Filed: Jan. 27, 2022
(86) PCT No.: PCT/CN2022/074241

§ 371 Date: Oct. 25, 2023

(30) Foreign Application Priority Data
Jul. 19, 2021 (CN) 202110813821.7

(51) Int. Cl. D04H 1/4374; B32B 5/02; B32B 5/26; D04H 1/26; D04H 1/4258; D04H 1/435; D04H 1/4382; D04H 1/44; D04H 3/16

(52) U.S. Cl. CPC D04H 1/4374; B32B 5/022; B32B 5/269; D04H 1/26; D04H 1/4258; D04H 1/435; D04H 1/43835; D04H 1/44; D04H 3/16; B32B 2250/03; B32B 2250/20; B32B 2250/40; B32B 2262/0284; B32B 2262/04; B32B 2262/062; B32B 2262/067; B32B 2262/124; B32B 2262/144; B32B 2307/726; B32B 2555/00; D10B 2401/063; D10B 2509/00

(57) ABSTRACT

A super-soft composite wiping non-woven fabric having a layered structure which contains two outer layers being melt-blown polyester fiber webs composed of melt-blown polyester fibers with a fiber length of 10 mm-50 mm and a fiber length-diameter ratio of 1100-8000; a middle fiber layer is mainly composed of water absorbent fibers; fiber interlacing and interpenetrating areas are arranged between one of the two outer layers and the middle fiber layer, as well as between another one of the two outer layers and the middle fiber layer.

### TECHNICAL FIELD

The present invention relates to the technical field of non-woven fabrics, and in particular to a soft and comfortable wiping non-woven fabric that is applied in personal care and infant care, and a manufacturing method therefor.

### BACKGROUND OF THE INVENTION

Wiping non-woven fabrics have gained popularity among consumers due to their convenience in carrying, storage, and use. Currently, most of the wiping non-woven fabrics are spunlace non-woven fabric products. Compared to traditional cloth wipes, the production of wiping non-woven fabrics is convenient and cost-effective, and these fabrics are suitable for both dry and wet usage. CN106283839 (Chinese invention patent application No. CN201610660119.0) titled “POLYESTER WOOD PULP WET-LAID SPUNLACED MATERIAL” discloses a spunlaced material produced through a wet-laid spunlacing process using polyester ultra-short staples and wood pulp as the main raw materials. The spunlaced material is a mixture of 10-80% by weight of polyester ultra-short staples, 0-5% by weight of reinforced ultra-short staples, and 15-90% by weight of wood pulp that have been beaten and fibrillated, whereas said percentages are calculated based on a total weight of all raw materials used. The spunlaced material is formed through a cross-laid spunlacing process, where the polyester ultra-short staples, the reinforced ultra-short staples, and the wood pulp are intertwined. However, because the spunlaced material is first wet-laid and then spunlaced during the forming process, with the wet-laid process resembling a paper-making process, the formed spunlaced material has a higher density, stiff texture, poor softness, and low wet strength. This affects the effect of use of the spunlaced material as wipes and reduces their service life.

### BRIEF SUMMARY OF THE INVENTION

### Technical Problems to be Solved

An object of the present invention is to provide a composite wiping non-woven fabric that is soft and comfortable and has higher mechanical strength, and a manufacturing method therefor, thereby overcoming the defects of the existing products and production methods.

### Technical Solutions to the Technical Problems

### Technical Solutions

To achieve the aforementioned object, the present invention provides a super-soft composite wiping non-woven fabric with a layered structure; two outer layers of the super-soft composite wiping non-woven fabric are both formed by melt-blown polyester fiber webs composed of melt-blown polyester fibers with a fiber length of 10 mm to 50 mm and a fiber length-to-diameter ratio of 1100 to 8000; a middle fiber layer in between the two outer layers of the super-soft composite wiping non-woven fabric is mainly formed by water absorbent fibers; fiber interlacing and intertwining areas exist between the one of the two outer layers and the middle fiber layer, as well as between another one of the two outer layers and the middle fiber layer respectively; wherein a weight of the middle fiber layer is more than 65% of a total weight of the super-soft composite wiping non-woven fabric; the melt-blown polyester fibers are formed from resin having a molecular structure that contains ester bonds, with a content of ester bonds in a single molecule being 70 to 100 and an intrinsic viscosity (represented by symbol [η]) being 0.50 to 0.68 dL/g.

The melt-blown polyester fibers are single-component fibers, bi-component melt-blown fibers of which each strand of fiber has an outer surface formed at least partially by a low-melting-point resin, or a mixture thereof.

The bi-component melt-blown fibers are bi-component sheath-core type melt-blown fibers, bi-component orange peel type melt-blown fibers, or bi-component side-by-side type melt-blown fibers.

The resin containing the ester bonds is polyethylene terephthalate or polybutylene terephthalate.

The water absorbent fibers in the middle fiber layer are mainly composed of viscose fibers, single-component or bi-component staples, natural fibers, or a mixture thereof.

The natural fibers are wood pulp fibers, cotton fibers, or a mixture thereof.

A weight percentage of the viscose fibers in the water absorbent fibers is greater than or equal to 15%.

A method for manufacturing the super-soft composite wiping non-woven fabric, comprising the following steps: (1) carding the water absorbent fibers into a fiber web using a carding machine, or opening and loosening the water absorbent fibers by a loosening roller, and forming the middle fiber layer through a nozzle under action of auxiliary airflow, wherein the water absorbent fibers are viscose fibers, wood pulp fibers, other fibers, or a mixture thereof;

(2) drying the resin having the molecular structure that contains the ester bonds; employing a melt-blown process, heating and melting the resin being dried in a screw extruder, then melt trickles of the heated and melted resin are ejected out from spinnerets respectively, and hot air flows through melt-blown die head assemblies upstream of the spinnerets respectively so that the melt trickles ejected out from the spinnerets are blown by the hot air into fiber bundles, which, together with flows of the hot air, form melt-blown polyester fiber webs that intertwine with two sides of the middle fiber layer respectively, thereby forming a multilayer fiber web composed of two outer layers formed by the melt-blown polyester fiber webs and a middle layer being the middle fiber layer, wherein the resin having the molecular structure that contains the ester bonds has 70 to 100 ester bonds in the single molecule thereof and the intrinsic viscosity of 0.50 to 0.68 dLg; a pressure of the hot air is 0.3 to 3 Mpa; the melt-blown polyester fibers of the melt-blown polyester fiber webs have the fiber length of 10 mm to 50 mm and the fiber length-to-diameter ratio of 1100 to 8000;

(3) consolidating the multilayer fiber web with a heating device to form the super-soft composite wiping non-woven fabric which has two outer layers being the melt-blown polyester fiber webs and a middle layer being the middle fiber layer.

The heating device is a hot air oven, a pair of press rollers, or a combination of both.

### Beneficial Effects of the Present Invention

### Beneficial Effects

According to the aforementioned structure and manufacturing method, the fiber length of the melt-blown polyester fiber webs on the two outer layers is 10 mm to 50 mm, and a length-to-diameter ratio of the melt-blown polyester fibers being 1100 to 8000. Compared to conventional polypropylene melt-blown fibers, the greater rigidity of polyester allows for the formation of longer fibers. These longer fibers contribute to an improved tactile sensation of the non-woven fabric, making it soft and comfortable to skin contact when used in wiping products, reducing the risk of skin irritation or allergies caused by fiber breakage. Additionally, the larger length-to-diameter ratio and smaller fiber diameter of the melt-blown polyester fibers lead to a denser arrangement of fibers on the outer surfaces of the resulting non-woven fabric. This prevents fibers from the middle fiber layer from easily escaping from the gaps on the melt-blown polyester fiber webs on both outer surfaces, thus preventing the occurrence of “fiber shedding” or “fiber dusting”. Moreover, melt-blown polyester fibers demonstrate better mechanical properties, offering tear resistance during use and improving their service life.

### BRIEF DESCRIPTION OF THE DRAWINGS

### Drawing Description

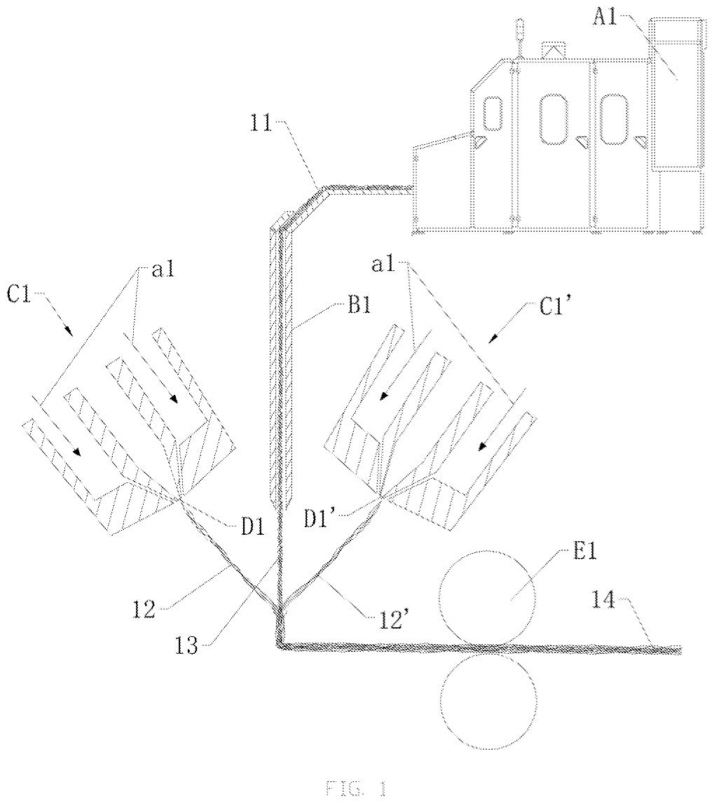

FIG. 1 is a schematic diagram of the manufacturing of the super-soft composite wiping non-woven fabric according to Embodiment 1 of the present invention.

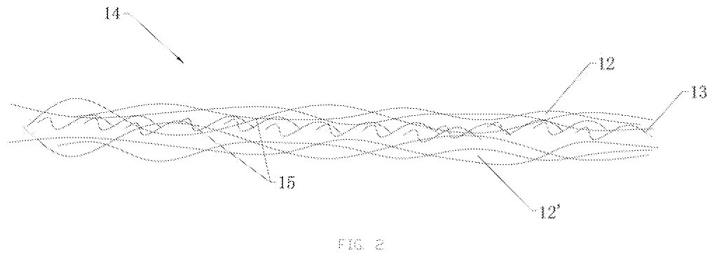

FIG. 2 is a cross-sectional view of the super-soft composite wiping non-woven fabric made according to Embodiment 1 of the present invention.

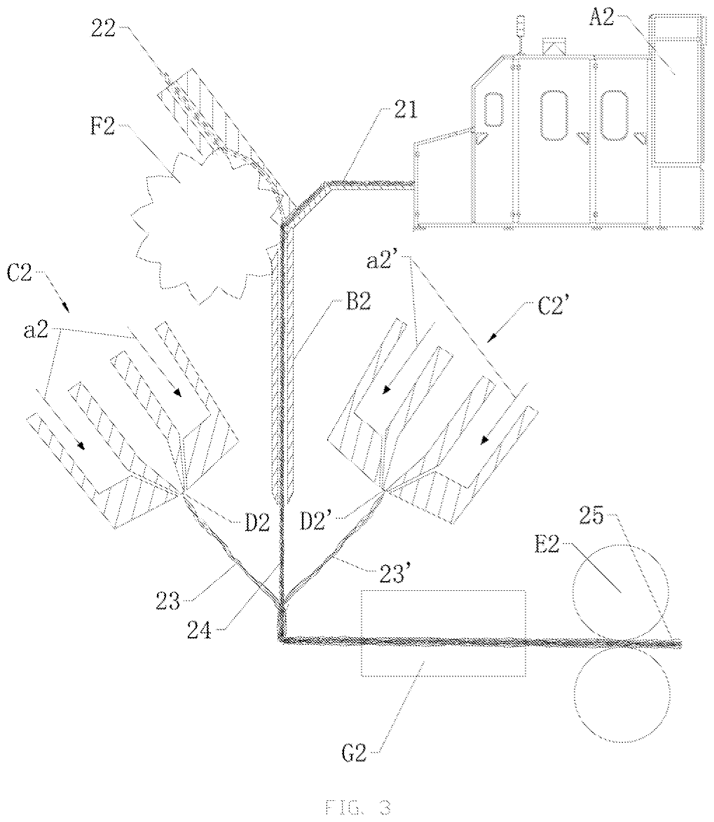

FIG. 3 is a schematic diagram of the manufacturing of the super-soft composite wiping non-woven fabric according to Embodiment 2 of the present invention.

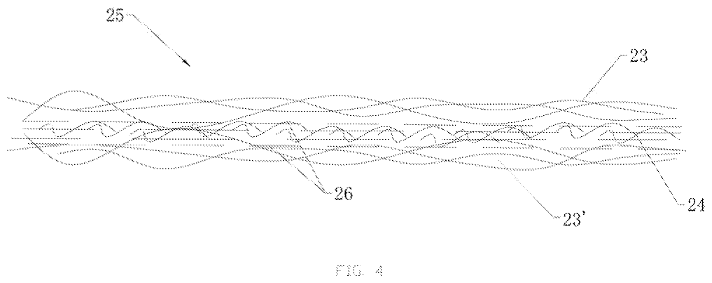

FIG. 4 is a cross-sectional view of the super-soft composite wiping non-woven fabric made according to Embodiment 2 of the present invention.

### DETAILED DESCRIPTION OF THE INVENTION

### Embodiments of the Present Invention

In order to further explain the technical solutions of the present invention, the present invention will be described in detail with some specific embodiments.

### Embodiment 1

As shown in FIGS. 1 and 2, viscose fibers are carded into a viscose fiber web 11 using a carding machine A1. A middle fiber layer 13 composed of the viscose fibers is formed from the viscose fiber web through a nozzle B1 under action of auxiliary airflow.

A polyethylene terephthalate resin with a content of 80 ester bonds in a single molecule and an intrinsic viscosity of 0.55 dL/g is dried. Employing a melt-blown process, wherein the polyethylene terephthalate resin being dried is heated and melted in a screw extruder (not shown in the figure), then melt trickles of the heated and melted polyethylene terephthalate resin are ejected out from spinnerets D1, D1′ respectively, and hot air a1, a1′ flows through melt-blown die head assemblies C1 and C1′ upstream of the spinnerets respectively so that the melt trickles ejected out from the spinnerets D1 and D1′ are blown by the hot air into ultra-fine fiber bundles, which, together with flows of the hot air, form melt-blown polyester fiber webs 12 and 12′ composed mainly of melt-blown polyester fibers. The formed melt-blown polyester fiber webs 12 and 12′ intertwine with two sides of the middle fiber layer 13 respectively, thereby forming a multilayer fiber web with two outer layers being the melt-blown polyester fiber webs 12 and 12′ respectively and a middle layer being the middle fiber layer 13; wherein a pressure of the hot air is 2.5 Mpa; the formed melt-blown polyester fibers have a fiber length of 25 mm and a fiber length-to-diameter ratio of 3800; the melt-blown polyester fibers are single-component polyester fibers, or bi-component sheath-core type melt-blown fibers, or bi-component orange peel type melt-blown fibers, or bi-component side-by-side type melt-blown fibers, or a mixture thereof, wherein the bi-component melt-blown fibers of any type mentioned above has each strand of fiber having an outer surface formed at least partially by a low-melting-point resin; a weight of the viscose fibers is 73% of a total weight of the composite wiping non-woven fabric.

The multilayer fiber web is consolidated with a pair of press rollers E1 to form an super-soft composite wiping non-woven fabric 14 with two outer layers being the melt-blown polyester fiber webs 12 and 12′ and a middle layer being the middle fiber layer 13 formed by the viscose fiber web 11, wherein fiber interlacing and intertwining areas exist between a first melt-blown polyester fiber web 12 and the middle fiber layer 13, and also between a second melt-blown polyester fiber web 12′ and the middle fiber layer 13.

### Embodiment 2

As shown in FIGS. 3 and 4, viscose fibers are carded into a viscose fiber web 21 using a carding machine A2. Wood pulp fibers 22 are opened and loosened by a loosening roller F2; and the wood pulp fibers 22 being opened and loosened are mixed with the viscose fiber web 21 to form a mixture, and then, a middle fiber layer 24 composed mainly of the mixture comprising said wood pulp fibers 22 and the viscose fiber web 21 is formed through a nozzle B2 under action of auxiliary airflow.

A polybutylene terephthalate resin with a content of 100 ester bonds in a single molecule and an intrinsic viscosity of 0.68 dL/g is dried. Employing a melt-blown process, wherein the polybutylene terephthalate resin being dried is heated and melted in a screw extruder (not shown in the figure), then melt trickles of the heated and melted polybutylene terephthalate resin are ejected out from spinnerets D2, D2′ respectively, and hot air a2, a2′ flows through melt-blown die head assemblies C2 and C2′ upstream of the spinnerets respectively so that the melt trickles ejected out from the spinnerets D2 and D2′ are blown by the hot air into ultra-fine fiber bundles, which, together with flows of the hot air, form melt-blown polyester fiber webs 23 and 23′. The formed melt-blown polyester fiber webs 23 and 23′ intertwine with two sides of the middle fiber layer 24 respectively, thereby forming a multilayer fiber web with two outer layers being the melt-blown polyester fiber webs 23 and 23′ respectively and a middle layer being the middle fiber layer 24; wherein a pressure of the hot air is 1.5 Mpa; the formed melt-blown polyester fibers have a fiber length of 47 mm and a fiber length-to-diameter ratio of 6900; the melt-blown polyester fibers are bi-component sheath-core type melt-blown fibers, or single-component polyester fibers, or bi-component orange peel type melt-blown fibers, or bi-component side-by-side type melt-blown fibers, or a mixture thereof, wherein the bi-component melt-blown fibers of any type mentioned above has each strand of fiber having an outer surface formed at least partially by a low-melting-point resin; a weight of the viscose fibers is 80% of a total weight of the composite wiping non-woven fabric.

The multilayer fiber web is first put into a hot air oven G2, such that the outer surface (which is at least partially formed by said low-melting-point resin) of the bi-component sheath-core type melt-blown fibers in upper and lower layers of the multilayer fiber web can be melted by hot air in the hot air oven to bond the fibers in the upper and lower layers respectively. Then, the multilayer fiber web is further consolidated with a pair of press rollers E2 to form a super-soft composite wiping non-woven fabric 25 with the upper and lower layers being the melt-blown polyester fiber webs 23 and 23′ and a middle layer in between the melt-blown polyester fiber webs 23 and 23′ being the middle fiber layer 24 composed of a mixture of the viscose fiber web 21 and the wood pulp fibers 22, wherein fiber interlacing and intertwining areas exist between a first melt-blown polyester fiber web 23 and the middle fiber layer 24, and also between a second melt-blown polyester fiber web 23′ and the middle fiber layer 24.

### Mechanical Property Testing.

Tensile strength testing was conducted using the XLW-100N Intelligent Electronic Tensile Tester with the following test parameters.

MD (machine direction): sample width: 50 mm, gauge length: 200 mm, stretching velocity: 100 m/min.

CD (cross direction): sample width: 50 mm, gauge length: 100 mm, stretching velocity: 100 m/min.

### Dusting Rate Testing.

Instruments: dusting rate tester, balance.

Reference testing standard: Dusting Rate Testing according to Appendix B of Chinese national standard GB/T 20810-2018 concerning “Toilet Tissue Paper”.

Testing steps: 1. Take approximately 150 g of sample, weigh it with the balance, and denote its weight as m1: fold the sample into a specimen of 200 mm in length, with longitudinal edges of the folded portions always in alignment during folding.

2. Fix one end of a longitudinal edge of the eventually folded specimen onto the specimen clamp, with specimen surfaces perpendicular to a swinging direction of the specimen during testing, and ensure that the specimen will not come into contact with inner walls of a chamber of the tester during testing.

3. Start the tester and let the specimen swing inside the chamber for 2 min, with a reciprocating frequency of 180±10 times/min and a swing distance of 100±5 mm.

4. After the test is completed, turn off the tester, remove the specimen, weigh the specimen and denote the weight as m2.

5. Calculate the dusting rate of the specimen according to the following formula: X=(m1−m2)+m1×100.

In the formula: X represents the dusting rate of the specimen in percentage; m1 represents the weight of the specimen before the test in gram (g); m2 represents the weight of the specimen after the test in gram (g).

### Fiber Length-to-Diameter Ratio Testing.

Fiber length-to-diameter ratio is a significant factor when assessing the apparent form and structure of fibers. Fiber length-to-diameter ratio has a considerable impact on web formation of the fibers and the formed structure of the resulting product.

Instruments: ruler, Keyence VHX-6000 super deep depth-of-field 3D digital microscope.

Testing steps: (1) Use a ruler to measure a length of a fiber. (2) Capture an image of the fiber using the Keyence VHX-6000 super deep depth-of-field 3D digital microscope. (3) Utilize its measuring software to measure the image by clicking plane measurement in the [Measurement/Ruler] section in the VHX menu to measure dimensions of the image. (4) Measure 20 sets for each type of fiber sample to obtain a fiber length L and a fiber diameter d of a corresponding fiber sample. (5) Calculate the fiber length-to-diameter ratio: length-to-diameter ratio=L×1000÷d.

L represents fiber length, mm.

d represents fiber diameter, μm.

### Softness Testing.

Testing instrument: Handle-O-Meter softness tester.

Test samples: 100 mm×50 mm, 5 pieces.

Testing steps: Adjust a slit width and loosen four screws of a platform, place selected slit dies (slit width: 5 mm), and adjust the platform to align the slit between the slit dies with a blade. Load a sample under the blade on the platform, with a testing direction perpendicular to an opening of the slit and a test position of the sample being a ⅓ position from one end of a width of the sample; close a protective cover of the testing instrument and initiate the test, with the blade moving downward, pressing the sample into the slit. The instrument records a maximum force value generated during the process.

Using the aforementioned test items and methods, the super-soft composite wiping non-woven fabrics produced in Embodiments 1 and 2 and conventional wiping non-woven fabrics are subject to testing and evaluation respectively, wherein the conventional wiping non-woven fabrics are a polyester wood pulp spunlace non-woven fabric and a polypropylene wood pulp melt-blown non-woven fabric with two outer layers being polypropylene melt-blown fiber webs and a middle layer formed by wood pulp.

| | | | | | Length-to- | |
|---|---|---|---|---|---|---|
| | Gram | Tensile strength | | Dusting | diameter | Softness |
| | weight | MD | CD | rate | ratio | (MD) |
| | Unit | | | | | |
| | g/m² | N/2 inch | N/2 inch | % | % | gf |
| Polyester wood | 65 | 125 | 30.2 | 0.25 | 960 | 46 |
| pulp spunlace | | | | | | |
| non-woven fabric | | | | | | |
| Polypropylene | 65 | 14.8 | 11.9 | 0.25 | 909 | 40 |
| wood pulp melt- | | | | | | |
| blown non-woven | | | | | | |
| fabric | | | | | | |
| Sample of | 65 | 33.2 | 15.6 | 0.17 | 3800 | 31 |
| Embodiment 1 | | | | | | |
| Sample of | 65 | 35.4 | 16.8 | 0.16 | 6900 | 30 |
| Embodiment 2 | | | | | | |

As can be seen from the above testing data, in the softness testing, the polyester in conventional polyester wood pulp spunlace non-woven fabric has a larger length-to-diameter ratio, resulting in an increased fiber diameter and therefore a lower softness. However, for samples from Embodiments 1 and 2, the fibers in the melt-blown polyester fiber webs on two outer layers have a larger length-to-diameter ratio and a longer fiber length, which facilitates a dense fiber arrangement, reducing fiber breakage and thereby significantly enhancing the softness of the non-woven fabric. Additionally, it prevents fibers from the middle fiber layer from easily escaping from the gaps of the melt-blown polyester fiber webs of the two outer layers, thus preventing the occurrence of “shedding” or “dusting”. Moreover, the middle fiber layer can also include other fibers like single-component or bi-component staples, natural fibers etc. The incorporation of other fibers imparts more characteristics to the composite wiping non-woven fabric. For example, the incorporation of single-component or bi-component staples, such as PET or PE/PP staples, can further reduce the dusting rate of the super-soft composite wiping non-woven fabric, preventing fiber shedding; while the incorporation of natural fibers, such as cotton fibers, can improve the softness and skin-friendly properties of the super-soft composite wiping non-woven fabric. In addition, from the tensile strength testing data, since the polypropylene fibers of the two outer layers of the polypropylene wood pulp melt-blown non-woven fabric have a shorter fiber length, low fiber rigidity, and looser bonding between fibers, samples from Embodiments 1 and 2, when compared to the polypropylene wood pulp melt-blown non-woven fabric, demonstrate better mechanical properties, offering tear resistance during use and improving their service life.

1: A composite wiping non-woven fabric with a layered structure; wherein two outer layers of the composite wiping non-woven fabric are both formed by melt-blown polyester fiber webs composed of melt-blown polyester fibers with a fiber length of 10 mm to 50 mm and a fiber length-to-diameter ratio of 1100 to 8000; a middle fiber layer in between the two outer layers of the composite wiping non-woven fabric is formed by water absorbent fibers; fiber interlacing and intertwining areas exist between one of the two outer layers and the middle fiber layer, as well as between another one of the two outer layers and the middle fiber layer respectively; wherein a weight of the middle fiber layer is more than 65% of a total weight of the composite wiping non-woven fabric; the melt-blown polyester fibers are formed from resin having a molecular structure that contains ester bonds, with a content of ester bonds in a single molecule being 70 to 100 and an intrinsic viscosity being 0.50 to 0.68 dL/g.

2: The composite wiping non-woven fabric of claim 1,
wherein the melt-blown polyester fibers are single-component fibers, bi-component melt-blown fibers of which each strand of fiber has an outer surface formed at least partially by a low-melting-point resin, or a mixture thereof.

3. (canceled)

4: The composite wiping non-woven fabric of claim 1,
wherein the resin containing the ester bonds is polyethylene terephthalate or polybutylene terephthalate.

5: The composite wiping non-woven fabric of claim 1,
wherein the water absorbent fibers in the middle fiber layer are viscose fibers, single-component or bi-component staples, natural fibers, or a mixture thereof.

6: The composite wiping non-woven fabric of claim 5, wherein the natural fibers are wood pulp fibers, cotton fibers, or a mixture thereof.

7: The composite wiping non-woven fabric of claim 5,
wherein a weight percentage of the viscose fibers in the water absorbent fibers is greater than or equal to 15%.

8. (canceled)

9. (canceled)
